(19) United States
(12) Patent Application Publication
(10) Pub. No.: US 2003/0086561 A1
(43) Pub. Date: May 8, 2003

(54) XDSL splitter module for field wiring cabinet

(76) Inventors: Bryce McLean, Saskatoon (CA); Mark Labbe, Saskatoon (CA)

Correspondence Address: ADE & COMPANY, 1700-360 MAIN STREET, WINNIPEG, MB, R3C3Z3, CA

(21) Appl. No.: 10/284,483

(22) Filed: Oct. 31, 2002

Related U.S. Application Data
(60) Provisional application No. 60/330,775, filed on Oct. 31, 2001.

(51) Int. Cl. H04M 1/00; H04M 9/00

(52) U.S. Cl. 379/413.02; 379/413.03

(57) ABSTRACT

The present invention provides a digital subscriber line (XDSL) splitter module that is installable in a telephony field wiring cabinet. Normally, the telephony field cabinet contains a jumper wire interface that is used to interconnect telephone trunk cables with telephone distribution cables. The splitter module operates on signals found on the wire pair extending to a customer premise and it contains a filter circuit to split the POTS and XDSL onto separate wire pairs. The separated XDSL signals can be carried on fiber optic or other high bandwidth media for the purpose of extending the transmission range. The separated POTS signals are directly carried on telephone trunk cables which provide voice service with well-known high reliability.

This application claims priority under 35 U.S.C. 119 from Provisional Application Serial No. 60/330,775 filed October 31, 2001.

This invention relates to a splitter module for use in splitting low frequency signals, primarily but not exclusively voice signals, from high frequency signals, primarily but not exclusively XDSL signals, in a telephone communications system.

### BACKGROUND OF THE INVENTION

In a telephone communications system serving a plurality of subscriber premises from a central office, ADSL (Asymmetric Digital Subscriber Line) is a modem technology that transmits high speed data over existing twisted-pair telephones lines concurrently with Plain Old Telephone Service (POTS) signals. VDSL is a higher speed variation of ADSL. The high speed data signals are at a higher frequency than the POTS signals, and circuits have been developed that can split the higher frequency data from the lower frequency POTS signal at either end of the transmission path. The term XDSL is used herein to generically refer to these different versions of transmitting higher frequency signals (e.g. ADSL, VDSL) over twisted pair concurrently with a relatively lower frequency signal (e.g., POTS). The terms “XDSL signal” and “POTS signal” are used herein to refer to at least two different frequency signals transmitted concurrently over twisted-pair wiring and that are intended to be separated, or split, at the subscriber equipment. The term “combined signals” is used to refer to both the XDSL and POTS signals combined over a line. It is understood that “XDSL signal” represents any information bearing high frequency signal and that “POTS signal” represents and lower frequency information signal and may include ISDN signals, telemetry signals or alarm signals.

An XDSL architecture connects an XDSL modem on each end of a twisted-pair telephone line. At one end of the line is the “central office” and at the other end is the premise of the subscriber (or customer). The term “splitter” is used to refer to a component or circuit, for example, a low pass filter or low pass and high pass filter combination, that separates the POTS signal from a combined signal, in the example of a low pass filter. In the example of the low pass and high pass filter combination, the splitter individually separates both the POTS and XDSL signals.

Splitters are typically housed in a separate enclosure and mounted near the network interface device (NID) at the subscriber. The NID provides a demarcation point, for at least the POTS signal, between the customer premise wiring and the telephone company distribution cable. A similar splitter is located at the central office or equivalent remote line unit and the splitter is normally associated with the XDSL modem. At the central office, the XDSL modem typically forms part of a digital subscriber line access module (DSLAM). The central office DSLAM may provide protocol conversion and statistical multiplexing and typically connects to higher speed networking equipment through fiber optic cable.

A problem with XDSL service deployment has been the limited range of transmission of these signals. In response to this problem, a recent development in XDSL system architecture has been to use remote DSLAM units that are associated with the conventional jumper wire interface (JWI) field cabinets. These remote DSLAM modules are then connected by several kilometers of fiber optic cable to the high speed networking equipment at the central office. A schematic illustration of this prior art arrangement of the JWI field cabinet and its associated remote DSLAM is shown in the Figures and described hereinafter.

The remote DSLAM units are located in a DSLAM cabinet and current practice is to provide a wire cable between the DSLAM cabinet and the JWI cabinet. In some installations, this cable can be more than one kilometer in length. One wire pair is used to bring the combined signal from the customer to the DSLAM cabinet where a splitter is used to route the XDSL signal to the DSLAM while the POTS signal is returned to the JWI cabinet through a second pair in the cable. Two problems exist with this practice. First, the POTS signal suffers additional attenuation by traveling to the DSLAM cabinet and back to the JWI cabinet. Second, to accommodate the paired wire cable that extends to the DSLAM cabinet, additional termination strips must be installed. A first jumper wire connects the trunk cable to the DSLAM cable and a second jumper wire connects the DSLAM cable to the distribution cable. Each XDSL equipped customer therefore requires twice the number of insulation displacing connectors at the JWI cabinet. As more customers subscribe to XDSL service, it is necessary to provide more connectors and to ultimately expand the cabinet. Such expansion is costly and may be considered unsightly by nearby residents.

An alternative arrangement, shown in Canadian Application No. 2,353,594 filed Jul. 6, 2001 by some of the present inventors and published Jan. 7, 2002, is used to communicate the XDSL signals from the central office to the remote (JWI) field cabinet.

### SUMMARY OF THE INVENTION

It is one object of the present invention to provide an arrangement of XDSL splitter module that locates the splitter in a different location from the prior art and may overcome or alleviate some or all of the above disadvantages.

According to a second aspect of the invention there is provided telecommunications apparatus comprising:

a central office, the central office being arranged to transmit telecommunications signals between the central office and the subscriber premises including low frequency signals and high frequency signals;

a plurality of subscriber premises;

a trunk cable having a plurality of wire pairs extending from the central office to a remote location;

a jumper wire interface (JWI) field cabinet at the remote location for connection of subscriber premises to the trunk cable;

a high frequency signal processing device;

a plurality of subscriber drop cables each having a wire pair extending from the JWI field cabinet to a respective one of the subscriber premises;

a plurality of terminal strips within the JWI cabinet arranged to connect respective wire pairs in the trunk cable to the wire pairs in the drop cables;

at least one splitter module having terminals on at least one terminal strip arranged for connection to selected ones of the wire pairs of the subscriber drop cables and to respective wire pairs of the trunk cable for splitting low frequency signals from the high frequency signals in the telecommunications signals;

the splitter module being shaped and arranged to be located within the JWI cabinet;

and at least one cable communicating separated high frequency signals from the at least one module to the high frequency signal processing device.

The low frequency signals are generally but not necessarily voice signals and the high frequency signals are generally but not necessarily XDSL signals.

Preferably the module includes a first terminal strip for connection to the wire pairs of the trunk cable and a second terminal strip for connection to the wire pairs of the subscriber drop cables.

Preferably the module contains a low pass filter for each of a plurality of subscriber wire pairs and a plurality of terminals equivalent to the number of low pass filters.

Preferably the or each module includes a single cable containing a plurality of connector pairs one for each of the low pass filters for communication of the high frequency signals from the JWI cabinet to the high frequency signal processing device.

Preferably the first and second terminal strips are arranged so as to be symmetrical to the connector terminal strips.

Preferably the first and second terminal strips on the module are parallel and one above the other.

Preferably the connector terminal strips are mounted on supports including guide channels for receiving and locating the trunk cable and/or the subscriber drop cables and wherein the module includes guide channels shaped and arranged to match the guide channels of the terminal strips.

Preferably the connector terminal strips are arranged in a plurality of vertical columns and wherein the module is located within one of the columns.

Preferably the module has a width substantially equal to one of the columns.

Preferably the module includes a rectangular housing with a bracket on the front face defining two guide channels at spaced positions across the front face.

Preferably the remote high frequency processing device is a DSLAM and is located in a separate housing and wherein the separate housing contains a high pass filter for each of the subscribers wire pairs. Alternatively, the high frequency processing device may be located in the same housing, that is the JWI cabinet, in which case it may be of the type claimed and disclosed in copending application entitled “EXTENDED DISTRIBUTION OF ADSL SIGNALS”, which is United States application for a patent filed Jul. 11, 2001, Ser. No. 09/902,444 and Canadian Application Serial No: 2,353,594 filed Jul. 6, 2001. The disclosure of this application is incorporated herein by reference.

Many of the above constructional details are particularly applicable to the construction arranged for use with the MS2 model manufactured by 3M. However other designs may be constructed with the same above principles but designed for other JWI boxes for example the MOX by Corning.

According to a second aspect of the invention there is provided a splitter module for use in a jumper wire interface (JWI) cabinet for splitting low frequency signals from high frequency signals comprising:

a housing;

a plurality of splitter circuits within the housing for splitting low frequency signals from high frequency signals;

each splitter circuit having a first pair of terminals on a first terminal strip for connection to a subscriber premises, a second pair of terminals on a second terminal strip for connection to a trunk cable for connection to a central office and a third pair of wires for connection to a remote high frequency processing device;

wherein the housing with the terminal strips thereon of the module are arranged to be similar in arrangement and location to connecting terminal strips in the JWI cabinet.

According to a third aspect of the invention there is provided a splitter module for use in a jumper wire interface (JWI) cabinet for splitting low frequency signals from high frequency signals comprising:

a housing;

a plurality of splitter circuits within the housing for splitting low frequency signals from high frequency signals;

each splitter circuit having a first pair of terminals for connection to a subscriber premises, a second pair of terminals for connection to a trunk cable for connection to a central office and a third pair of wires for connection to a remote high frequency processing device;

wherein the module is arranged to be similar in arrangement and location to connecting terminals in the JWI cabinet.

One advantage of the present invention is the elimination of the round trip travel of the voice signal between the JWI cabinet to the DSLAM cabinet.

### BRIEF DESCRIPTION OF THE DRAWINGS

FIG. 1 is block diagram of the prior art showing the arrangement of a JWI field cabinet, the DSLAM field cabinet together with the trunk and distribution cables;

FIG. 2 is plan view of the JWI connectors within the JWI field cabinet of FIG. 1.

FIG. 3 is schematic diagram of a conventional splitter circuit for use in the splitter of the present invention.

FIG. 4 is an isometric view of a splitter module according to the present invention for use in the JWI cabinet of FIGS. 1 and 2.

FIG. 5 is a top plan view of the module of FIG. 4.

FIG. 6 is a schematic view similar to that of FIG. 1 showing the arrangement of the present invention where the splitter module is located in the JWI cabinet leaving the DSLAM cabinet available only for the conventional DSLAM equipment.

FIG. 7 is a schematic view of a preferred embodiment of the splitter module of the present invention mounted in the JWI cabinet along side the conventional IDC terminal strips.

FIG. 8 is a top plan view of the module of FIG. 6.

### DESCRIPTION OF THE PRIOR ART

The structure of the conventional Jumper Wire Interface JWI Field cabinet 3 is shown in FIG. 1. Connections between trunk cable pairs 1 and distribution cable pairs 2 are typically formed using insulation displacing connectors that are assembled in columns 12, 13. In one part of the JWI, there are “trunk strips” 12A, each mounted on a column 12 or 13 and forming the termination for 25 wire pairs from a trunk cable. In another part of the JWI there are “distribution strips” 13A each mounted on a column 12 or 13 and used to terminate 25 wire pairs from a distribution cable. A jumper wire 4 is used to connect two terminals on a trunk strip to two terminals on a distribution strip. Jumper wires can be removed and re-inserted in the insulation displacing connectors and therefore the connections can be reconfigured in response to customer requests for new services.

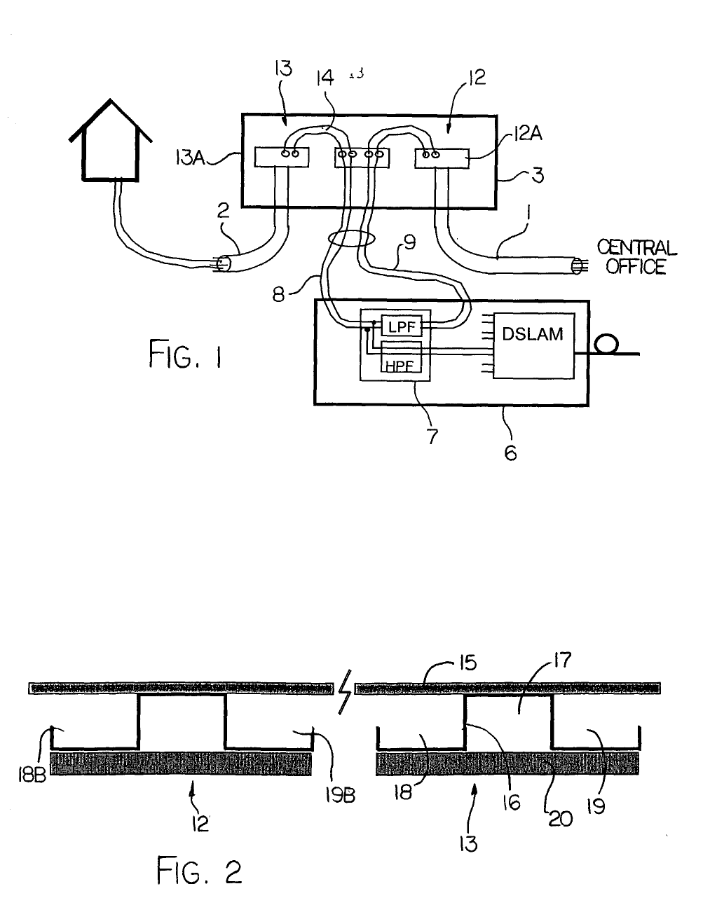

In FIG. 2, two of the columns are indicated at 12 and 13 and are of a conventional structure including a back board 15, a support bracket 16 defining a central open channel 17 and two side channels 18 and 19. The bracket supports the terminal strips 20 of a conventional nature. The channels 18 and 19 are conventionally used as open channels for the jumper wires. The central channel 17 provides an open channel for the trunk cable or for the distribution cable.

In the prior art arrangement of FIG. 1, the remote DSLAM equipment is located in a housing 6 including the splitter 7 having a high pass filter HPF and a low pass filter LPF. The splitter is connected to the cables in the JWI cabinet by jumper wires 8 and 9.

### DETAILED DESCRIPTION OF THE PREFERRED EMBODIMENT

In FIG. 6 is shown the construction of the present invention which replaces the arrangement shown in FIG. 1 of the prior art.

Thus the splitter unit generally indicated at 7A is mounted in the JWI cabinet 3 and is shaped and arranged so that it can be located in one of the columns 12, 13 generally provided for the IDC terminal strip for the distribution cable. In the arrangement shown there are three such columns generally indicated at 12, 13 and 14 this is merely shown schematically.

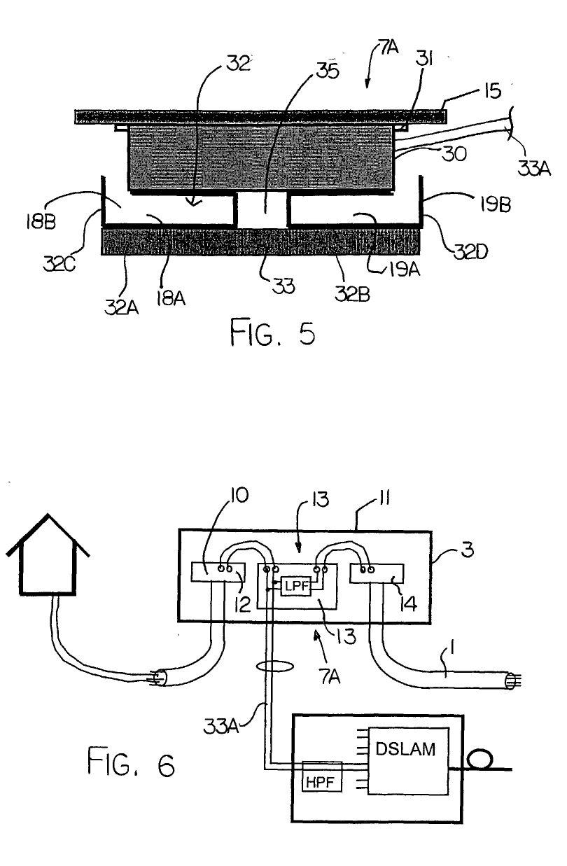

In FIG. 4 is shown an isometric view of the splitter module 7A according to the present invention. In FIG. 5 is shown a top plan view of the same module. The module comprises a housing 30 within which the circuitry is contained. The housing 30 includes a back plate 31 attached to the back board 15 of the JWI housing 3. On the front of the housing is provided two brackets 32 each of which supports a respective terminal strip 33 dimensioned and located so as to match the conventional terminal strips 20 (FIG. 2) of the conventional columns in the JWI cabinet.

Thus the terminal strip includes a number of terminals matching the number of the conventional terminal strip. In the prime example herein, this would be 25 terminals. Thus there are two terminal strips 33 arranged one above the other in front of the housing 30. Each terminal strip has the same number of terminals matching the conventional number. One strip 33 is used for the connection to the pairs from a plurality of the customer premises. The other strip 33 is used for connection to the respective trunk pairs. A cable 33A includes the respective pairs for connection to the DSLAM equipment. The housing contains the same number of the splitter circuits necessary for the terminals.

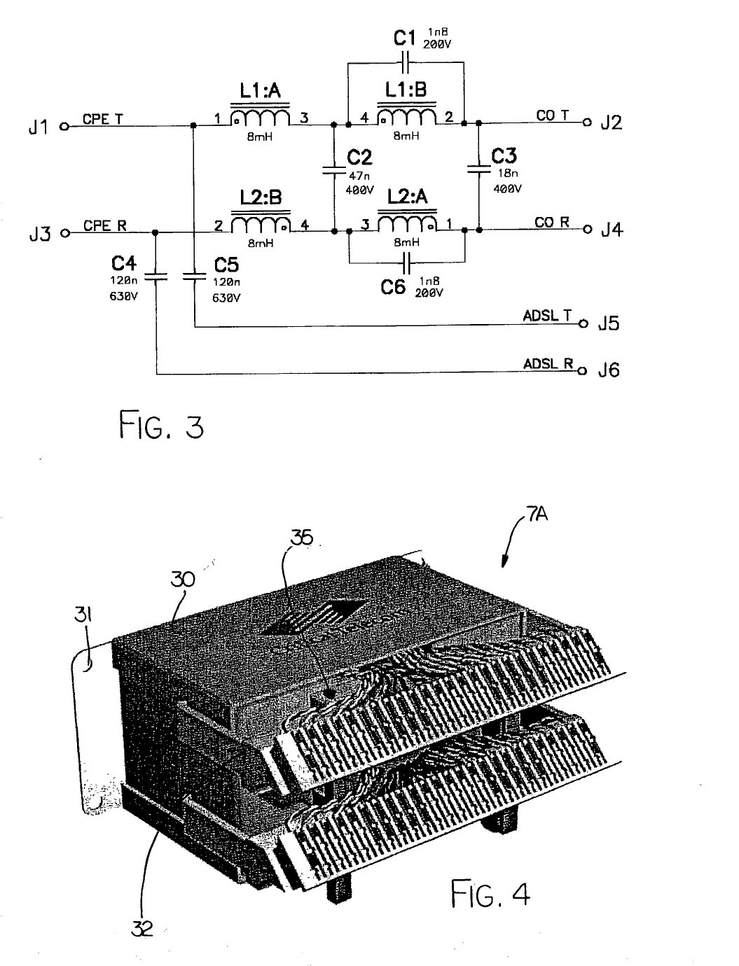

The circuitry for the splitters in the housing is of the type generally shown in FIG. 3 and comprises for each customer, as is well known, an array of inductors and capacitors arranged to act as a low pass filter connected across the terminals J1 and J3 for connection to the customer premises to separate the low frequency or voice signals for connection to the central office through the trunk cable at terminals J2 and J4 and the high frequency or XDSL signals for connection to the DSLAM through the cable 33A at J5 and J6. The circuitry shown schematically in FIG. 3 is constructed and arranged using conventional design arrangements well known to one skilled in the art so that the circuitry for each of the terminals and its circuit board are configured and dimensioned to fit within the housing 30.

The housing 30 is shaped and arranged so that it in effect is located within the same volume as the three channels 17, 18 and 19 of the conventional column. However the circuitry within the housing 30 is significantly larger than a central channel 17 so that the bracket 32 is shaped to redefine the shapes of the side channels 18A and 19A so that they are shallower in the front to rear direction and wider in the side to side direction. Thus the bracket includes a central support portion 35 which is narrower than the channel 17 thus allowing the channels 18A and 19A to be wider between the central support 35 and two side plates 18B and 19B which match the conventional side plates 18B and 19B of the conventional column. The sheet metal bracket 32 thus includes two front plates 32A and 32B extending outwards toward the sides of the housing along the front of the housing and two side pieces 32C and 32D which extend from the outer ends of the front pieces rearwardly parallel to the sides to a position outward of the sides and rearwardly of the plane of the front face. The front pieces carry the terminal strip 33.

Thus the splitter module is designed so that it can be placed within the cabinet. This can be mounted at the top of an existing column if a space is available or if a top extension of the housing is provided. This can alternatively be mounted by removing one of the existing columns and locating the splitter modules in a vertical row within that column. This acts to locate the terminal strips 33 in a row in a conventional manner matching the terminal strips existing within the housing.

The number of modules mounted within the housing depends upon the number or proportion of customers subscribing to the DSL system. In some cases the number may be relatively low so that only a low number of the modules is required and the modules can be mounted within the housing at available space within the columns. In other cases, the number of subscribers may be high thus requiring some of the existing terminal strips to be removed and replaced by the splitter modules. Alternatively an extension to the housing can be constructed.

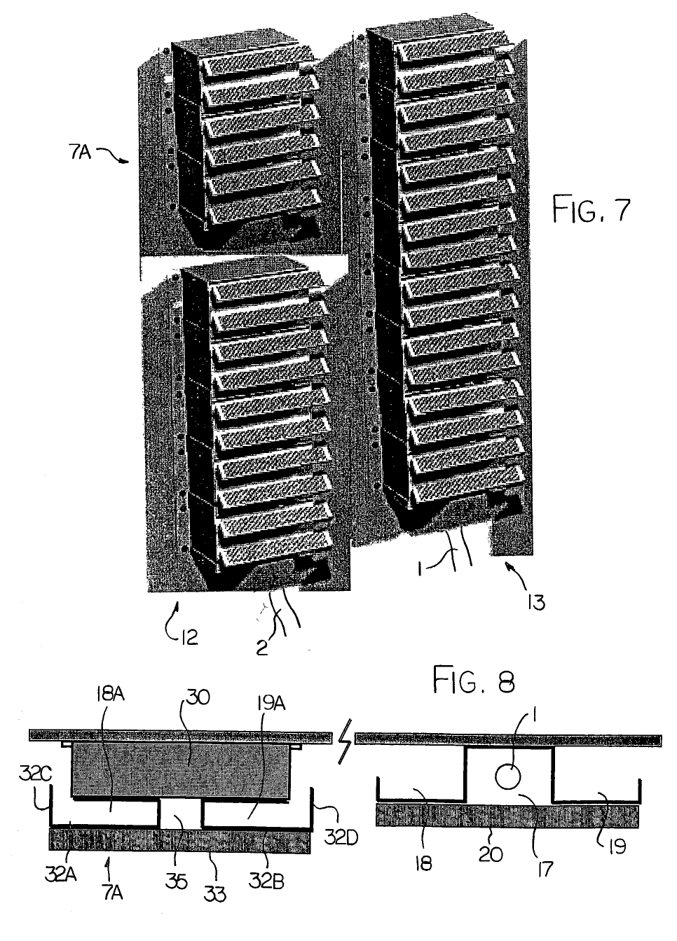

In a typical arrangement shown in FIG. 7 the trunk cable 1 enters the central channel 17 of one of the splitter columns. The distribution cable 2 enters the central column 17 of another of the columns. At the top of the left hand column is provided the splitter module 7A which provides the conventional channels 18A and 19A for the jumper wires. A conventional jumper wire which is unconnected to a splitter and used for normal couplings within the JWI cabinet passes from the channel 18A of one column to the channel 18 of the next column. Similarly the jumper wire which is available from the splitter also can pass through channel 18A to the next column.

The invention therefore provides in the first aspect the concept of locating the splitter in the JWI cabinet instead of the specially provided DSLAM cabinet. This avoids the necessity for the additional loop described above between the JWI and the DSLAM cabinet.

In order to achieve this it is necessary to design a splitter module which is shaped and arranged so that it can quickly located within the existing JWI cabinet.

This is conveniently carried out by shaping and arranging the module so that it matches existing columns in that it provides the circuitry within a housing which is shaped and arranged to receive within the area behind the conventional terminal strips. In addition the housing is shaped and arranged so that it allows the provision of the required channels for the jumper wires behind the location of the terminal strips and in front of the front face of the housing. Where each filter has been specifically designed to operate in the hash environment afforded by a JWI or similar cabinet

The particular design shown is applicable to the JWI cabinet manufactured by 3M under the model designation MS2 and location and arrangement of the terminal strip to match these columns is designed to be suitable for this particular construction. This arrangement has 25 terminals on an existing terminal strip of the constriction and layout described and shown above. The module thus has 25 or 24 splitter circuits and the matching number of terminals on each of the terminal strips together with a cable of a matching number of pairs for connection to the separate DSLAM equipment.

Alternative constructions are available which provide the terminals in different arrangements on location and the design and arrangement of a module to match these constructions can also be provided. For example an alternative arrangement of a very different appearance and construction is manufactured by Corning under the model designation MOX. The present circuit and PCB assembly is different from existing splitters because it has been designed with components that will work over the wide temperature, humidity, and dust ranges inside the JWI field cabinet. The reason we might want to include this is for a slight protection on a variation of the product that doesn't have MS2 style connectors, rather it has three pig tail cables.

1. Telecommunications apparatus comprising:
a central office, the central office being arranged to transmit telecommunications signals between the central office and the subscriber premises including low frequency signals and high frequency signals;
a plurality of subscriber premises;
a trunk cable having a plurality of wire pairs extending from the central office to a remote location;
a jumper wire interface (JWI) field cabinet at the remote location for connection of subscriber premises to the trunk cable;
a high frequency signal processing device;
a plurality of subscriber drop cables each having a wire pair extending from the JWI field cabinet to a respective one of the subscriber premises;
a plurality of terminal strips within the JWI cabinet arranged to connect respective wire pairs in the trunk cable to the wire pairs in the drop cables;
at least one splitter module having terminals on at least one terminal strip arranged for connection to selected ones of the wire pairs of the subscriber drop cables and to respective wire pairs of the trunk cable for splitting low frequency signals from the high frequency signals in the telecommunications signals;
the splitter module being shaped and arranged to be located within the JWI cabinet;
and at least one cable communicating separated high frequency signals from the at least one module to the high frequency signal processing device.

2. The apparatus according to claim 1 wherein the module includes a first terminal strip for connection to the wire pairs of the trunk cable and a second terminal strip for connection to the wire pairs of the subscriber drop cables.

3. The apparatus according to claim 1 wherein the module contains a low pass filter for each of a plurality of subscriber wire pairs and a plurality of terminals equivalent to the number of low pass filters

4. The apparatus according to claim 3 wherein the or each module includes a single cable containing a plurality of connector pairs one for each of the low pass filters for communication of the high frequency signals from the JWI cabinet to the high frequency signal processing device.

5. The apparatus according to claim 1 wherein the first and second terminal strips are arranged so as to be symmetrical to the connector terminal strips.

6. The apparatus according to claim 2 wherein the first and second terminal strips on the module are parallel and one above the other.

7. The apparatus according to claim 1 wherein the connector terminal strips are mounted on supports including guide channels for receiving and locating the trunk cable and/or the subscriber drop cables and wherein the module includes guide channels shaped and arranged to match the guide channels of the terminal strips.

8. The apparatus according to claim 1 wherein the connector terminal strips are arranged in a plurality of vertical columns and wherein the module is located within one of the columns.

9. The apparatus according to claim 8 wherein the module has a width substantially equal to one of the columns.

10. The apparatus according to claim 1 wherein the module includes a rectangular housing with a bracket on the front face defining two guide channels at spaced positions across the front face.

11. The apparatus according to claim 1 wherein the remote high frequency processing device is located in a housing separate from the JWI cabinet.

12. The apparatus according to claim 11 wherein the separate housing contains a high pass filter for each of the subscribers wire pairs.

13. A splitter module for use in a jumper wire interface (JWI) cabinet for splitting low frequency signals from high frequency signals comprising:
a housing;
a plurality of splitter circuits within the housing for splitting low frequency signals from high frequency signals;
each splitter circuit having a first pair of terminals for connection to a subscriber premises, a second pair of terminals for connection to a trunk cable for connection to a central office and a third pair of wires for connection to a remote high frequency processing device;
wherein the module is arranged to be similar in arrangement and location to connecting terminals in the JWI cabinet.

14. A splitter module for use in a jumper wire interface (JWI) cabinet for splitting low frequency signals from high frequency signals comprising:
a housing;
a plurality of splitter circuits within the housing for splitting low frequency signals from high frequency signals;
each splitter circuit having a first pair of terminals on a first terminal strip for connection to a subscriber premises, a second pair of terminals on a second terminal strip for connection to a trunk cable for connection to a central office and a third pair of wires for connection to a remote high frequency processing device;
wherein the housing with the terminal strips thereon of the module are arranged to be similar in arrangement and location to connecting terminal strips in the JWI cabinet.

15. The module according to claim 14 wherein the module includes a single cable containing a plurality of connector pairs one for each of the low pass filters for communication of the high frequency signals from the JWI cabinet to the high frequency signal processing device.

16. The module according to claim 14 wherein the first and second terminal strips are arranged so as to be symmetrical to the connector terminal strips in the JWI cabinet.

17. The module according to claim 14 wherein the first and second terminal strips on the module are parallel and one above the other.

18. The module according to claim 14 wherein the module includes guide channels shaped and arranged to match the guide channels of the terminal strips of the JWI cabinet.

19. The module according to claim 14 wherein, in the JWI cabinet, the connector terminal strips are arranged in a plurality of vertical columns and wherein the module is shaped and arranged to be located within one of the columns.

20. The module according to claim 19 wherein the module has a width substantially equal to one of the columns.

21. The module according to claim 14 wherein the module includes a rectangular housing with a bracket on the front face defining two guide channels at spaced positions across the front face.
